(19) United States
(12) Patent Application Publication
(10) Pub. No.: US 2006/0170366 A1
(43) Pub. Date: Aug. 3, 2006

(54) Lighting device, lighting unit and method for heating lighting device by heating device disposed thereon

(76) Inventors: Jim S. Powell, San Marcos, CA (US); Eric C.H. Chen, Hsin Chu Hsien (TW)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/297,185

(22) Filed: Dec. 8, 2005

(30) Foreign Application Priority Data
Jan. 31, 2005 (TW) 094102938

(51) Int. Cl. H05B 41/36

(52) U.S. Cl. 315/106

(57) ABSTRACT

A heating unit having a heating function is provided in the present invention. The heating unit comprises a lighting device, a case containing the lighting device, a heating device formed on the case for heating the case, a heat sensor having a preset value and electrically connected to the heating device for detecting a thermal parameter of the lighting device, and a timer having a preset period and electrically connected to the heating device, wherein the heating device is shut off by the heat sensor when the thermal parameter is a temperature and higher than the preset value or by the timer when the thermal parameter is a heating time of the heating device and longer than the preset period.

### FIELD OF THE INVENTION

The present invention is related to a lighting device, and more particularly, the present invention is related to a lighting device, a lighting unit and a method for heating the lighting device by a heating device disposed thereon.

### BACKGROUND OF THE INVENTION

Lighting equipment is indispensable to our daily life and needed almost everywhere and at any time. Initialization of these lighting devices are generally dependent on temperature since electronic devices therein are temperature sensitive. At some places, temperature is too low to initialize the lighting devices, such as the places without electricity facility and on some transportation means which does not move on and follow rails, such as vehicles or vessels. When such situations are encountered, the lighting devices have to be particularly dealt with so as to be normally initialized.

In principle, the lighting device, such as a fluorescent lamp, emits light since electrons therein strike vaporized metal, e.g. the mercury, in the device and thus an invisible light, such as the ultraviolet ray, is emitted. The invisible light then hits the fluorescent lamp, resulting successively in visible light emission. If the temperature reduces, however, the vaporized metal may condense as a liquid or even a solid form, making it difficult for the electrons to strike the metal for the invisible light emission. Simply speaking, the fluorescent light is hard to be initialized in the low temperature environment.

In the prior art, heating the fluorescent lamp is a solution to the low temperature problem. Referring to FIG. 1, the conventional fluorescent lamp is shown therein. As shown in FIG. 1, a heating filament 3 is disposed in the fluorescent lamp 1 to heat and gasify the condensed metal so as to strike the gaseous metal with the electrons to generate the invisible light. To maintain the heating filament 3 and the fluorescent lamp 1 to be bonded closely, means like a gripper has to be provided as a fixing means. In FIG. 1, a receptive body 2 and a cover body 20 are served as the fixing means. When the heating filament 3 and the fluorescent lamp 1 are to be assembled together by the fixing means, a process for pacing the heating filament 3 into the receptive body 2 is required in which a relative position specification between the heating filament 3 and the fluorescent lamp 1 has to be carefully followed. In this case, production speed of the fluorescent lamp 1 is lowered and possibility of a mistreated process on the production lines is increased. In addition, the manufacturing cost of the receptive body 1 and the cover body 20 is additionally required. Therefore, such fluorescent lamp still leaves something to be considered.

With regard to the bonding of the heating filament and the fluorescent lamp, there is another scheme where the heating filament is wound outside the florescent lamp so as to heat the florescent lamp in a full-range manner. However, since the heating filament is provided circumferentially with respect to the fluorescent lamp, light provided by the florescent lamp might be not uniform enough from a user's view since portions of the light from the fluorescent lamp is shielded by the surrounding heating filament.

Furthermore, since the heating filament is wound along an outer surface of the fluorescent lamp and thus not formed integrally with the fluorescent lamp, a clearance may unavoidably exist. To maintain the heating filament and the fluorescent lamp in a closely bonded state to secure a good thermal conduction therebetween, an adhesive agent is required to be provided. However, the adhesive agent would not be effective after a long use, causing the heating filament falling off from the fluorescent lamp. Thus, such fluorescent lamp still has to seek an improvement.

Therefore, it is needed to set forth a fluorescent lamp with a heating device for heating the lamp, in which the heating device is bonded closely with the lamp, no clearance exists between the heating device and the lamp, the relative position between the heating device and the lamp is free from being additionally taken care and thus assembly time of the fluorescent lamp is exempted from increasing, and a non-uniform heating effect due to the improper relative position possibly taken place is exempted. In the same sense, other lighting units are also long felt.

### SUMMARY OF THE INVENTION

To achieve the above-mentioned object, the present invention provides a heating unit having a heating function. The heating unit comprises a lighting device, a case containing the lighting device, a heating device formed on the case for heating the case, a heat sensor having a preset value and electrically connected to the heating device for detecting a thermal parameter of the lighting device, and a timer having a preset period and electrically connected to the heating device, wherein the heating device is shut off by the heat sensor when the thermal parameter is a temperature and higher than the preset value or by the timer when the thermal parameter is a heating time of the heating device and longer than the preset period.

The above lighting device further comprises a power source for supplying a power to the lighting device and the heating device.

Preferably, the power source comprises a regulator so as to regulate the power required for the lighting device and heating device.

Preferably, the heat sensor is a thermal sensitive resistance.

Preferably, the lighting unit is a cold cathode fluorescent lamp.

Preferably, the heating device is a resistance heater and formed by a method selected from a group consisting of evaporation, electroplating, printing and painting.

Preferably, the heat sensor detects the thermal parameter by connecting the lighting device.

The present invention also provides a lighting device having a heating function, comprising a case having a heating device disposed thereon and formed integrally with the lighting device.

Preferably, the lighting device further comprises a heat sensor connected electrically to the heating device and having a preset value therein, wherein the heat sensor detects a thermal parameter of the lighting device and shuts off the heating device when the thermal parameter is higher than the preset value.

Preferably, the lighting device further comprises a timer connected electrically to the heating device and having a preset period and shutting off the heating device when a heating time of the heating device is over the preset time period.

Preferably, the heating device is made of a material selected from a group consisting of carbon paste, silver paste, ceramic base Ag paste, polymer base Ag paste, nickel-chromium alloy, and aluminum alloy.

Preferably, the lighting device is a cold cathode fluorescent lamp.

The present invention also provides a method for heating a lighting device by a heating device disposed thereon, the method comprises the steps of heating the lighting device and stopping heating the lighting device when a thermal parameter of the lighting device is a temperature and higher than a preset value or when the thermal parameter of the lighting device is a heating time of the lighting device and longer than a preset period.

Preferably, the method further comprises a step, prior to the step of heating the lighting device, of determining if the thermal parameter is lower than a preset low-level temperature, and the step (a) is performed when the lighting device is determined as having the thermal parameter lower than the preset low-level temperature.

Preferably, the method further comprises a step, successive to the step of stopping heating the lighting device, of powering up the lighting device.

### BRIEF DESCRIPTION OF THE DRAWINGS

FIG. 1 is a schematic diagram of a prior art lighting device having a heating device;

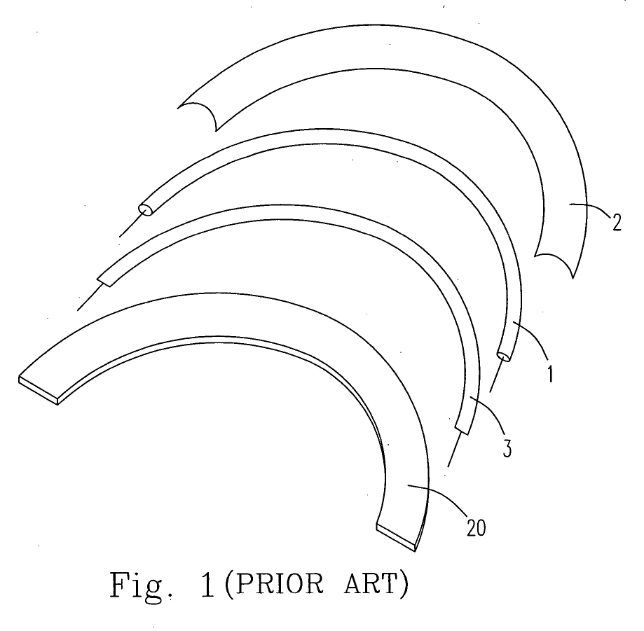

FIG. 2 is a schematic diagram of a lighting device having a heating device according to an embodiment of the present invention;

FIG. 3 is a block diagram of a lighting unit having the lighting device shown in FIG. 2 according to the present invention; and

FIG. 4 is a flowchart illustrating a method for heating the lighting device by the heating device disposed thereon lighting unit having the lighting device shown in FIG. 2 according to the present invention.

### DETAILED DESCRIPTION OF THE PREFERRED EMBODIMENT

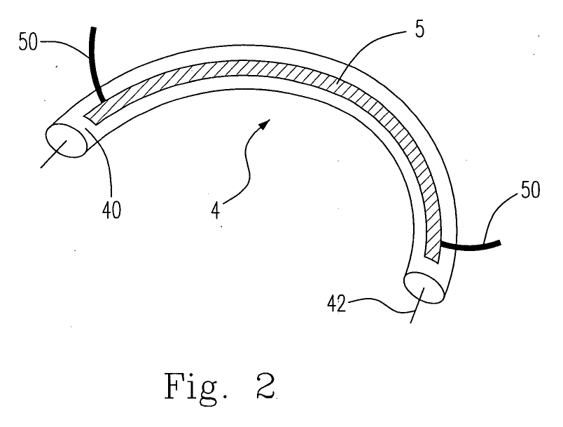

Referring to FIG. 2, a lighting device having a heating device according to an embodiment of the present invention is schematically shown therein. As shown in FIG. 2, the lighting device 4 has a case 40 on which a heating device 5 is disposed. As such, the lighting device 4 is a lighting device having the heating device 5. The heating device 5 is made of a material having a relatively greater resistance or a material which may produce relatively more heat when an electrical power is applied thereon. As examples, the heating device 5 may be made of a material selected from a group consisting of carbon paste, silver paste, ceramic base Ag paste, polymer base Ag paste, nickel-chromium alloy, and aluminum alloy. To avoid light emitted from the lighting device 4 from being hindered by the heating device 5, the heating device 5 may be made of a transparent material so that the heating device 5 may produce heat with the power applied and the produced light may pass therethrough simultaneously.

To enable the heating device 5 to be more closely bonded onto the case 40, the heating device 5 is formed on the lighting device 4 by electroplating, evaporating, coating, printing and the like. By means of these methods, the heating device 5 and the lighting device 4 may be assured to have a closer bonding without any seam, compared with that obtained by any method used in the art, enabling the heat produced by the heating device 5 to be effectively transmitted to the case 40 in a thermal conductive manner 6. In this case, condensed metal in the case 40 may be transformed into gaseous metal owing to the produced heat. The power required for light emitting of the lighting device is inputted through a first conduction wire 42. When electrons generated by the power strikes the gaseous metal, an invisible light is emitted. Then, the invisible light contacts a florescent material provided on an inner surface of the case 40, enabling a visible light to be emitted. As such, the lighting device 4 provides the visible light.

Since the heating device 5 is formed on the lighting device 4, they are formed integrally. In this case, shape of the heating device 5 may vary as that of the lighting device 4 varies. This can be an advantage of the present invention since the heating device 5 does not come off from the lighting device 4 when the lighting device 4 gets deformed, which is benefited from the integral combination of the light device 4 and the heating device 5.

For car use, the lighting device 4 is generally a cold cathode fluorescent lamp (CCFL). The CCFL has already had its typical size specifications, and electronic connections of the power supply therefor have been mostly formulated. Therefore, the CCFL may be directly and simply applied to the present invention without the need of changing its shape and number of the electronic connections. In operation, a first conduction wire 42 is connected electrically to a second conduction wire 50, i.e. the heating device 5 is connected in parallel with the lighting device 4. As such, the power required for the heating device 5 may be acquired from that supplying for the lighting device 5. Accordingly, a user may install the lighting device 4 directly on an existing lamp holder without the need of any modification to the lamp holder, making the inventive lighting device easy to be used.

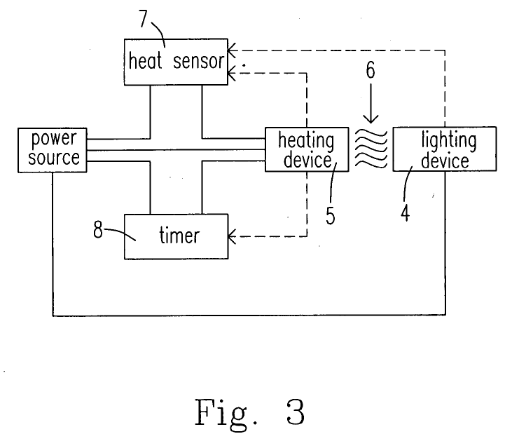

Now reference is made to FIG. 3, which is a block diagram of a lighting unit having the lighting device shown in FIG. 2 according to the present invention. To more effectively perform the present invention, a heat sensor 7 may be provided in cooperation with the lighting device 4. Specifically, the heat sensor 7 is provided with a preset value and contacts with the heating device 5 or the lighting device 4 so as to sense their temperatures. When the temperature of the heating device 5 or the lighting device 4 is over the preset value, the heat sensor 7 shuts off the heating device 5 to avoid the heating device 5 or the lighting device 4 from being damaged. Preferably, the heat sensor 7 is a thermal sensitive resistance.

Referring again to FIG. 3, a timer 8 may be provided to the lighting unit to further enhance performance of the lighting unit. Specifically, the timer 8 has a preset period and is connected electrically to the heating device 5. When a heating time of the lighting device 4 is over the preset period, the timer 8 shuts off the heating device 5 so as to prevent the heating device 5 or the lighting device 4 from being damaged.

As may be known from FIG. 3, the power source for the timer 8, the heating device 5, the lighting device 4 and the heat sensor 7 may be the same. In real operation, through the electronic connections existing in the currently available lamp holder, the power from the power source is supplied to the elements 8, 5, 4 and 7 concurrently if each of the elements 8, 5, 4 and 7 requires the power.

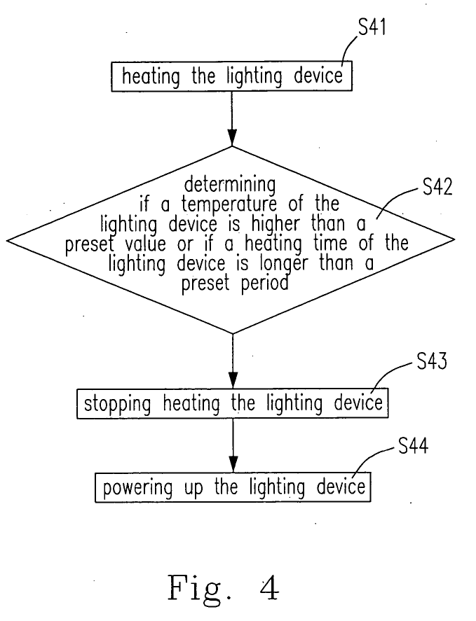

The present invention also provides a method of heating a lighting device by a heating device disposed thereon, as shown in FIG. 4, which may be applied to the lighting unit shown in FIG. 3. The method comprises the following steps. First, the lighting device is heated (S41). Then, whether a temperature of the lighting device is higher than a preset value or whether a heating time of the lighting device is longer than a preset period is determined (S42). If any one of the two conditions is met, stop heating the lighting device (S43). As such, the heating device may be automatically shut off and does not suffer any damage due to overheating. Furthermore, a step S40 may be additionally provided prior to the step S41 to determine if the lighting device has the temperature lower than a preset low-level temperature, and the step S41 is performed when the lighting device is determined as having the temperature lower than the preset low-level temperature. In addition, a step of powering up the lighting device (S44) may be provided successive to the step S43, so that the power for the lighting deice may be turned on only after the temperature of the lighting device has risen up to make the metal in the lighting device gasify or the heating time of the light device has been detected as longer than the preset value. When either of the conditions is reached, the heat sensor or the timer sends a signal to the power source so as to commence a power supply to the lighting device. As such, the power consumption may be saved and an activator and stablizer of the CCFL may each have a prolonged lifetime. In this way, the lighting device may not only be heated in a cost-efficient manner but also in a device-protective manner.

Preferably, a regulator may be provided although not shown, so that the heating device 5 and the lighting device 4 may be supplied with a stable current.

The lighting device has been described as the CCFL for car use. However, the present invention also contemplates other types of lighting device. In case of a battery in a car, the power source requires an inverter (not shown) to obtain an alternating current (AC) power for the CCFL from the supplied direct current (DC) power.

While the invention has been disclosed in terms of what is presently considered to be the most practical and preferred embodiments, it is to be understood that the invention needs not to be limited to the disclosed embodiments. On the contrary, it is intended to cover various modifications and similar arrangements included within the spirit and scope of the appended claims which are to be accorded with the broadest interpretation so as to be accorded with the broadest interpretation so as to encompass all such modifications and similar structures.

1. A heating unit having a heating function, comprising:
a lighting device;
a case containing said lighting device;
a heating device formed on said case for heating said case;
a heat sensor connected electrically to said heating device for detecting a thermal parameter of said lighting device; and
a timer having a preset period and connected electrically to said heating device.

2. The lighting device according to claim 1, wherein said heating device is shut off by said heat sensor when said thermal parameter is a temperature and higher than a preset value and by said timer when a heating time of said heating device is longer than said preset period.

3. The lighting device according to claim 1, further comprising a power source.

4. The lighting device according to claim 2, wherein said power source comprises a regulator to rectify an electrical power outputted therefrom.

5. The lighting device according to claim 1, wherein said heat sensor is a thermal sensitive resistance.

6. The lighting device according to claim 1, wherein said lighting unit is a cold cathode fluorescent lamp.

7. The lighting device according to claim 1, wherein said heating device is a resistance heater and formed by a method selected from a group consisting of evaporation, electroplating, printing and painting.

8. The lighting device according to claim 1, wherein said heat sensor detects said thermal parameter by connecting said lighting device.

9. A lighting device having a heating function comprising a case and a lighting device disposed thereon and formed integrally with said lighting device.

10. The lighting device according to claim 9, further comprising a heat sensor connected electrically to said heating device and having a preset value, wherein said heat sensor detects a temperature and shuts off said heating device when said temperature is higher than said preset value.

11. The lighting device according to claim 9, further comprising a timer connected electrically to said heating device and having a preset period, wherein said heating device is shut off by said timer when a heating time of said heating device is longer than said preset period.

12. The lighting device according to claim 9, wherein a material of said heating device is selected from a group consisting of carbon paste, silver paste, ceramic base Ag paste, polymer base Ag paste, nickel-chromium alloy, and aluminum alloy.

13. The lighting device according to claim 9, wherein said lighting device is a cold cathode fluorescent lamp.

14. A method for heating a lighting device by a heating device disposed thereon, comprising the steps of:
heating said lighting device; and
stopping heating said lighting device when a thermal parameter of said lighting device is higher than a preset value or longer than a preset period.

15. The method according to claim 14, further comprising a step (a′), prior to said step (a), of determining if said lighting device has said thermal parameter lower than a preset low-level temperature and said step (a) is performed when said lighting device is determined as having said thermal parameter lower than said preset low-level temperature.

16. The method according to claim 14, further comprising a step (c), successive to said step (b), of powering up said lighting device.

17. The method according to claim 14, wherein said thermal parameter is a temperature and said preset value is a temperature value.

18. The method according to claim 14, wherein said thermal parameter is a heating time of said heating device and said preset value is a time value.

19. The method according to claim 14, wherein said lighting device is a cold cathode fluorescent lamp.
